(19) United States
(12) Patent Application Publication
(10) Pub. No.: US 2009/0266250 A1
(43) Pub. Date: Oct. 29, 2009

(54) Infinitely variable cut off printing press and method of varying cut off

(75) Inventors: Ken Francis Blaney, Rochester, NH (US); Michael Robert Lemelin, Madbury, NH (US)

Correspondence Address: Davidson, Davidson & Kappel, LLC, 485 7th Avenue, 14th Floor, New York, NY, 10018, US

(73) Assignee: Goss International Americas, Inc., Dover, NH (US)

(21) Appl. No.: 12/149,205

(22) Filed: Apr. 28, 2008

(51) Int. Cl. B41F 5/16

(52) U.S. Cl. 101/178

(57) ABSTRACT

A variable cutoff printing press is provided including a first plate cylinder with a first plate disposed about the first plate cylinder and having a first image portion. A first blanket cylinder transfers the first image portion to a web at a first location. A second plate having a second image portion is disposed about the second plate cylinder. A second blanket cylinder transfers the second image portion to the web at a second location. An impression cylinder contacts the first blanket cylinder and the second blanket cylinder via the web. The first image portion and the second image portion form one continuous image having an image cutoff length. A method of printing an image on a web with a cutoff using a variable cutoff offset printing press is also provided.

### BACKGROUND OF INVENTION

The present invention relates generally to a printing press and more specifically to a variable cut off printing press and method.

U.S. Pat. No. 5,950,536 discloses a variable cutoff offset press unit wherein a fixed cutoff press is adapted to a variable cutoff press while maintaining the size of the blanket cylinders. A plate cylinder sleeve has a variable outer diameter, whereby a length of an image to be printed is varied proportionally to a variable outer diameter while maintaining an outer diameter of the gapless blanket cylinder sleeve constant. The size of a plate cylinder is changed by using a sleeve mounted over the plate cylinder or adding packing under a plate to increase the diameter of the plate cylinder.

U.S. Pat. No. 6,327,975 discloses a method and apparatus for printing elongate images on a web. A first printing unit prints a first image portion on the web at prescribed spacings, by moving the impression cylinder away from the blanket cylinder each time one first image portion is printed. A second printing unit prints a second image portion on the spacings left on the web by the first printing unit, also by moving the impression cylinder away from the blanket cylinder each time one second image portion is printed. A variable velocity motor rotates each blanket cylinder, while each time the associated impression cylinder is held away to create a space on the web for causing printing of the first or the second printing portion at required spacings.

U.S. Pat. No. 7,066,088 discloses a variable cut-off offset press system and method of operation which utilizes a continuous image transfer belt. The offset printing system comprises at least two plate cylinders adapted to have thereon respective printing sleeves. Each of the printing sleeves is adapted to receive colored ink from a respective ink source. The system further comprises at least a impression cylinder, wherein the image transfer belt is positioned to contact each of the printing sleeves at respective nips formed between respective ones of the plate cylinders and the at least one impression cylinder.

### BRIEF SUMMARY OF THE INVENTION

A variable cutoff printing press is provided including a first plate cylinder with a first plate disposed about the first plate cylinder and having a first image portion. A first blanket cylinder transfers the first image portion to a web at a first location. A second plate having a second image portion is disposed about the second plate cylinder. A second blanket cylinder transfers the second image portion to the web at a second location. An impression cylinder contacts the first blanket cylinder and the second blanket cylinder via the web. The first image portion and the second image portion form one continuous image having an image cutoff length.

A method of printing an image on a web with a cutoff using a variable cutoff offset printing press is provided including the steps of dynamically adjusting the position of a first blanket cylinder while the first blanket cylinder is not in contact with an impression cylinder, moving the first blanket cylinder into contact with the impression cylinder and printing a first image portion transferred to the first blanket cylinder by a first plate of a first plate cylinder on the web while the position of the second blanket cylinder is dynamically adjusted while the second blanket cylinder is not in contact with the impression cylinder, moving the second blanket cylinder into contact with the impression cylinder and printing a second image portion transferred to the second blanket cylinder by a second plate of a second plate cylinder in a position on the web that is aligned with the second image portion so as to form a continuous image on the web having a first image cutoff length, removing the first plate and replacing the first plate with a first replacement plate having a second replacement image portion and removing the second plate and replacing the second plate with a second replacement plate having a second replacement image portion, and transferring the first replacement image portion to the first blanket cylinder and printing the first replacement image portion on the web and transferring the second replacement image portion to the second plate cylinder and printing the second replacement image portion on the web so that the first replacement image portion and the second replacement image portion form a continuous replacement image on the web having a second image cutoff length.

### BRIEF DESCRIPTION OF THE DRAWINGS

The present invention is described below by reference to the following drawings, in which:

FIG. 1 shows a schematic side view of a printing unit of an offset printing press according to an embodiment of the present invention;

FIG. 2 shows a schematic side view of a four color offset printing press according to an embodiment of the present invention;

FIG. 3 shows a schematic side view of a four color offset printing press with one central impression cylinder according to an embodiment of the present invention;

FIG. 4 shows a schematic side view of the printing unit shown in FIG. 1 with the first printing pair on impression printing a first image portion and the second printing pair off impression;

FIG. 5 shows the printing unit shown in FIG. 4 in a non-printing position, with both printing pairs off impression;

FIG. 6 shows the printing unit shown in FIG. 4 with the first printing pair on impression printing a subsequent first image portion and the second printing pair on impression printing a second image portion;

FIG. 7 shows the printing unit shown in FIG. 4 in a nonprinting position, with both blanket cylinders off impression;

FIG. 8 shows a schematic top view of a portion of a web on which the printing unit shown in FIGS. 4 to 7 printed two continuous images;

FIG. 9a shows a schematic side view of the first plate cylinder shown in FIG. 4 to 7, with a plate disposed about the surface of the first plate cylinder;

FIG. 9b shows a schematic top view of the plate shown in FIG. 9a removed from the first plate cylinder and laying flat; and

FIG. 10 shows a graph of the position of web versus the surface speed of the cylinders of the first printing unit for various ratios of the printing length of the plate of the first plate cylinder to the plate length of the plate of the first plate cylinder according to the operations performed by the printing press shown in FIGS. 4 to 7, with the first plate cylinder including the plate shown in FIGS. 9a and 9b.

### DETAILED DESCRIPTION

Variable cut off printing presses have been developed to allow for printing products of different sizes on the same printing press without having to change plate and blanket cylinders. Changing plate and blanket cylinders to correspond to the size of the image that needs to be printed can be a time consuming and difficult process and may require purchasing and storing cylinders of multiple sizes.

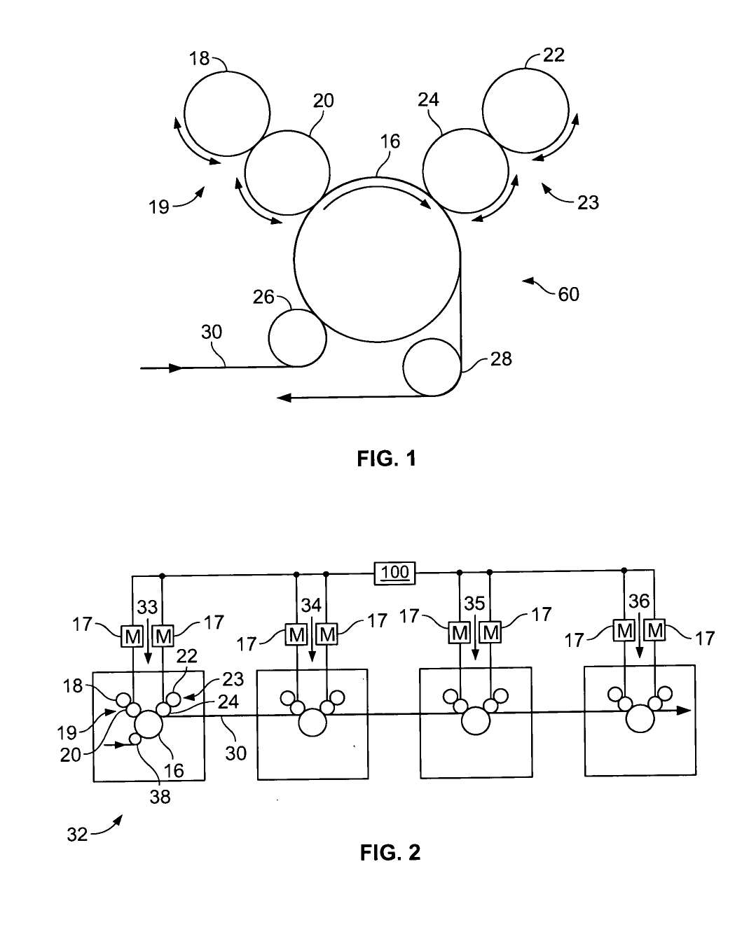

FIG. 1 shows a schematic side view of a printing unit 60 of an offset printing press according to an embodiment of the present invention. The printing unit 60 includes an impression cylinder 16, a first plate cylinder 18, a first blanket cylinder 20, a second plate cylinder 22, a second blanket cylinder 24, a first nip roll 26, a second nip roll 28, and a web 30 passing through the printing unit 60. Arrows show the direction that web 30 travels. Plate cylinders 18, 22 include respective printing plates. Blanket cylinders 20, 24 include respective printing blankets. First plate cylinder 18 and first blanket cylinder 20 form a first printing pair 19 and second plate cylinder 22 and second blanket cylinder 24 form a second printing pair 23. Printing unit 60 may be one of four printing units of a four color offset printing press 32 (shown in FIG. 2), the single unit of a printing press that only prints in one color, or the printing unit of any other printing press known to one of skill in the art. Regardless of the configuration of the printing press that printing unit 60 is included, both printing pairs 19, 23 of printing unit 60 print in same color ink.

First printing pair 19 prints a first image portion of set dimensions on web 30. Ink is fed by inkers to first plate cylinder 18, which transfers an inked image, the first image portion, to first blanket cylinder 20. First blanket cylinder 20 then prints the first image portion on web 30. Second printing pair 23 prints a second image portion of set dimensions on web 30. Ink is fed by inkers to second plate cylinder 22, which transfers an inked image, the second image portion, to second blanket cylinder 24. Second blanket cylinder 24 then prints the second image portion on web 30. Printing pairs 19, 23 are timed and phased such that each image portion is perfectly aligned with the other image portion, so that the first and second image portions together form one continuous image of set dimensions. This arrangement allows, for example, printing unit 60 to print a single continuous image with a cut off that is greater than the outer circumference of each individual blanket cylinder 20, 24 or plate cylinder 18, 22.

First nip roll 26, second nip roll 28, and impression cylinder 16 control web 30 and the speed of web 30. The path of web 30 is maintained even without blanket cylinders 20, 24 being associated with impression cylinder 16. Therefore, plate and blanket cylinders 18, 20, 22, 24 may throw on and off without affecting the tension or speed of web 30.

The outer circumferences of cylinders 18, 20, 22, 24 may be equal, which is preferred, or the circumferences may vary between printing pairs 19, 23. If all of the cylinders 18, 20, 22, 24 have the same outer circumference and the length of the image portion printed by each printing pair 19, 23 equals the circumference of each plate cylinder 18, 22, then the continuous image may have a cut off that is twice the circumference of each plate cylinder 18, 22. The image portion printed by each printing pair 19, 23 may be shorter than the circumference of each plate cylinder 18, 22. For example, each printing pair prints an image portion that is a length that is three-quarters the length of the circumference of each plate cylinder 18 and 22 and the cut off of the continuous image printed is equal to the length of one and a half of the circumference of one plate cylinder 18, 22. In another embodiment, the image portion printed by first printing pair 19 may be of different length than the image portion printed by the second printing pair 23. For example, the image printed by first printing pair 19 may be of a length equal to half the outer circumference of plate cylinder 18, while the image portion printed by second printing pair 23 may only be of a length equal to three quarters of the outer circumference of plate cylinder 22.

An operator of printing unit 60 can vary the cut off length of the continuous image by varying the length of the inked image produced by each plate cylinder 18, 22. Plates may be disposed on plate cylinders 18, 22 carrying inked images of a set length, or image portions. These plates can be removed and replaced with replacement plates carrying image portions of lengths different from the previous image portions. These replacement image portions, when printed on the web, forms a replacement continuous image of a different cutoff length than the previous continuous image.

Therefore, instead of an operator of printing unit 60 having to change plate cylinders 18, 22 and blanket cylinders 20, 24 when a different cut off length is required, the operator only needs to alter the length of the inked image by imaging the plate on each plate cylinder 18, 22 and leaving the rest of the plate blank. If a cut off length is needed that is more than the combined outer circumferences of plate cylinders 18, 22, one or more additional printing pairs may be added to printing unit 60, assuming impression cylinder 16 is large enough. Additional printing pairs may operate in the same manner as printing pairs 19, 23, aligning the printed image portions of the additional printing pairs with the adjacent image portions. This allows printing unit 60 to print a wide variety of printed products with numerous different cut off lengths on the same printing press.

FIG. 2 shows a schematic side view of a four color offset printing press 32 according to an embodiment of the present invention. Printing press 32 includes four printing units 33, 34, 35, 36, each including a first printing pair 19 including a first plate cylinder 18 and a first blanket cylinder 20, a second printing pair 23 including a second plate cylinder 22 and a second blanket cylinder 24, an impression cylinder 16, motors 17 driving the blanket cylinders 20, 24, and a controller 100 controlling the operation of the motors 17. A web 30 passes through the printing units 33, 34, 35, 36 in the direction of the arrow. A single nip roll 38, directs web 30 as web 30 enters first printing unit 33. Unlike the printing unit 60 in FIG. 1, the blanket cylinders 20, 24 of each printing unit 33, 34, 35, 36 in this embodiment assist in controlling the web 30.

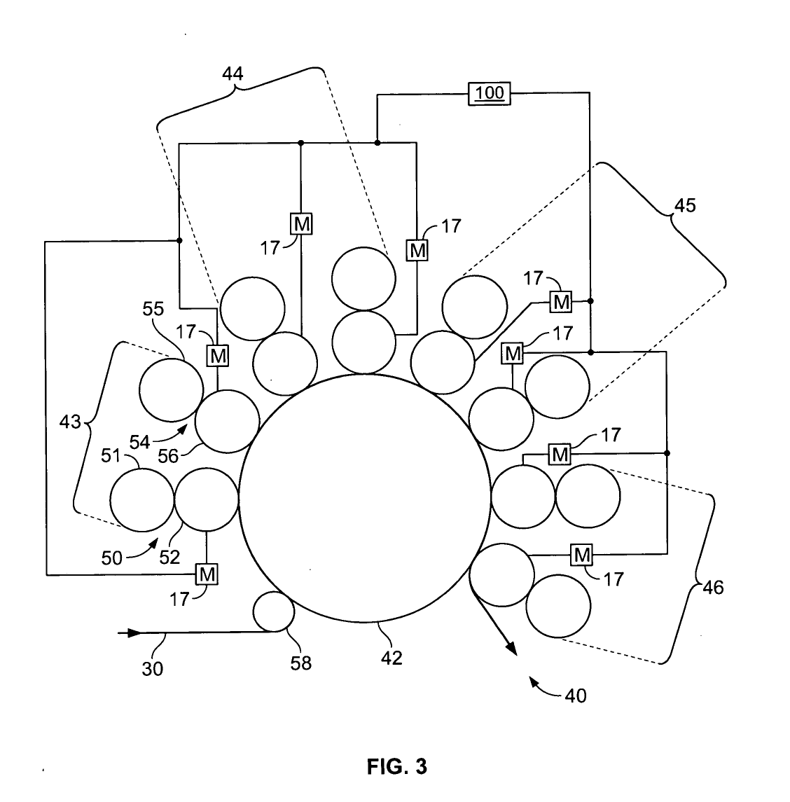

FIG. 3 shows a schematic side view of a four color offset printing press 40 with one central impression cylinder 42 according to an embodiment of the present invention. A first printing unit 43, a second printing unit 44, a third printing unit 45, and a fourth printing unit 46 are disposed about the central impression cylinder 42 print on a web 30 that passes between print units 43, 44, 45, 46 and central impression cylinder 42. Each printing unit 43, 44, 45, 46 includes a first printing pair 50 and a second printing pair 54. First printing pair 50 includes a first plate cylinder 51 and a first blanket cylinder 52. Second printing pair 54 includes a second plate cylinder 55 and a second blanket cylinder 56. Each printing pair 50, 54 of each printing unit 43, 44, 45, 46 is driven by a respective motor 17. In an alternative embodiment each cylinder 51, 52, 55, 56 is driven by a separate motor. Motors 17 of the printing units 43, 44, 45, 46 are controlled by a controller 100. Each printing unit 43, 44, 45, 46 prints in a different color on web 30, with first printing pair 50 and second printing pair 54 of each printing unit 43, 44, 45, 46 printing the same color, respectively. A nip roll 58 directs web 30, in the direction of the arrow, into contact with impression cylinder 42. First printing pair 50 of each printing unit 43, 44, 45, 46 prints a first image portion in a particular color ink on web 30 and second printing pair 54 of each printing unit 43, 44, 45, 46 prints a second image portion in the same color ink on the web 30 in alignment with the first image portion so as to create one continuous image. Each printing unit 43, 44, 45, 46 prints a continuous image of a respective color on web 30 so that the four continuous images overlap and form a single four color image on web 30.

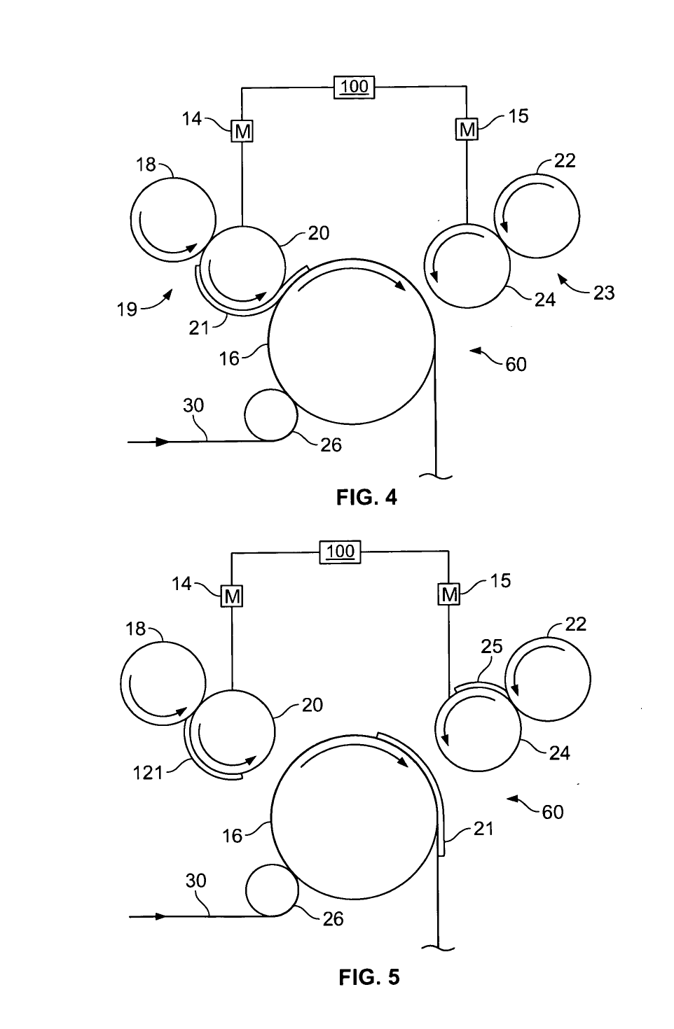

FIGS. 4 to 7 show printing unit 60 of FIG. 1 printing image portions that form continuous images. A controller 100 directs a first motor 14 and a second motor 15 to dynamically adjust the positioning of printing pairs 19, 23, respectively, accelerating and decelerating plate cylinders 18, 22 and blanket cylinders 20, 24, so blanket cylinders 20 and 24 print on web 30 in the proper location at the proper time. In another embodiment, separate motors drive each cylinder 18, 20, 22, 24. Cylinders 18 and 20 may be traveling at substantially the same speed during printing operations and cylinders 22 and 24 may be traveling at substantially the same speed printing operations.

FIG. 4 shows a schematic side view of printing unit 60 shown in FIG. 1 embodiment with first printing pair 19 on impression printing a first image portion 21 and second printing pair 23 off impression. First blanket cylinder 20 is contacting impression cylinder 16 via web 30, therefore first printing unit 19 is on impression, blanket cylinder 20 is printing first image portion 21 on web 30. Second printing pair 23 is off impression, thus blanket cylinder 24 is not in contact with impression cylinder 16 via web 30, and second motor 15 is dynamically adjusting the position of cylinders 22, 24 so that blanket cylinder 24 is in position to print a second image portion 25 (shown in FIGS. 5 to 7) directly behind first image portion 21 on web 30.

Once first blanket cylinder 20 has printed first image portion 21 on the web, first printing pair 19 goes off impression. FIG. 5 shows a schematic side view of the printing unit 60 shown in FIG. 4 in a non-printing position, with both printing pairs 19, 23 off impression. Second motor 15 is dynamically adjusting the position of cylinders 22 and 24 so that blanket cylinder 24 prints second image portion 25 directly behind first image portion 21 on web 30 when second printing pair 23 goes on impression. First motor 14 is dynamically adjusting the position of cylinders 18, 20 so that blanket cylinder 20 prints a subsequent first image portion 121 a distance behind first image portion 21 equal to the length of second image portion 25, which second blanket cylinder 24 prints on web 30.

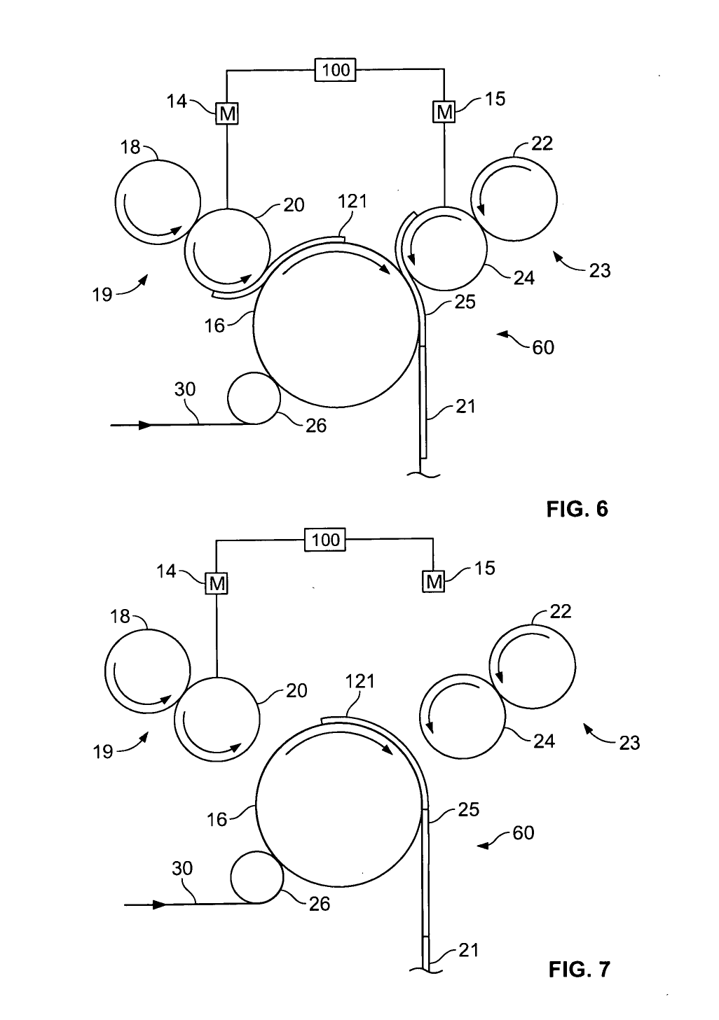

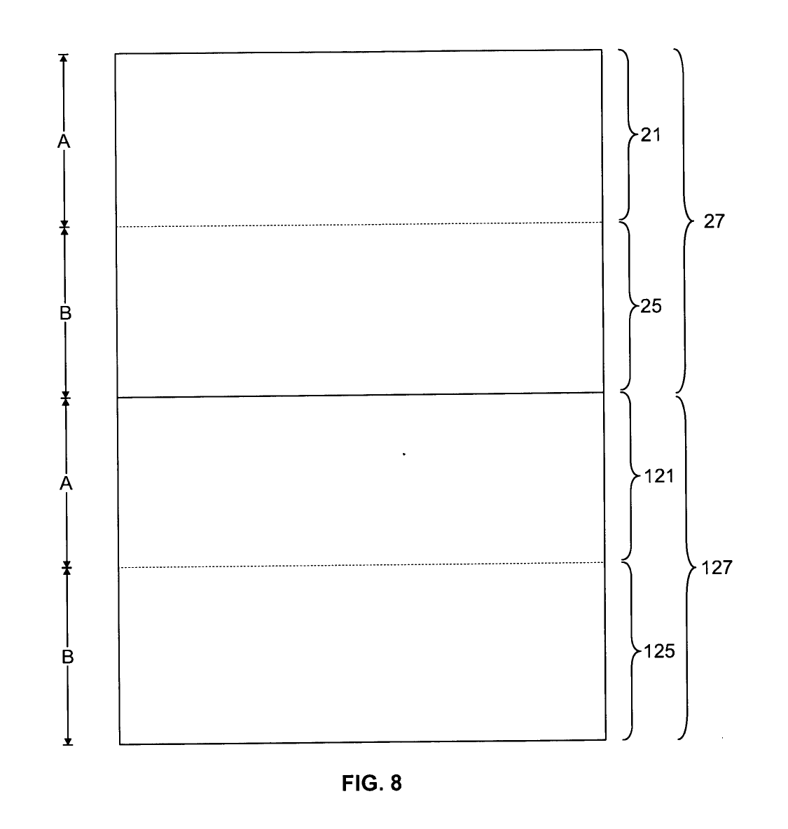

Next, second printing pair 23 goes on impression and blanket cylinder 24 prints second image portion 25 behind first image portion 21 on web 30 so that there is no space between image portions 21, 25 on web 30 and so image portions 21, 25 form one continuous image 27 (FIG. 8). FIG. 6 shows the printing unit shown in FIG. 4 with first printing pair 19 on impression printing a subsequent first image portion 121 and second printing pair 23 on impression printing second image portion 25. First blanket cylinder 20 is printing subsequent first image portion 121 on web 30 a distance behind image portion 21 equal to the length of second image portion 25.

After printing second image portion 25 second printing pair 23 goes off impression. FIG. 7 shows a schematic side view of printing unit 60 shown in FIG. 4 in a nonprinting position, with printing pairs 19, 23 off impression. Second printing pair 23 is off impression with motor 15 dynamically adjusting the position of second blanket cylinder 24 so that second blanket cylinder 24 is in position to print a subsequent second image portion 125 (FIG. 8) on web 30 immediately behind subsequent first image portion 121 to form a subsequent continuous image 127 (FIG. 8). First printing pair 19 is off impression with motor 14 dynamically adjusting the position of first blanket cylinder 20 so that first blanket cylinder 20 is in position to print another first image portion on web 30 that is the length of image portion 125 behind image portion 121, leaving a space for cylinder 24 to print image portion 125. First blanket cylinder 20 then contacts impression cylinder 16 as shown in FIG. 4 and operations as shown in FIGS. 4 to 7 and described above are repeated. Numerous continuous images, without any unprinted space in between, are printed on web 30 by blanket cylinders 20, 24. In the embodiment shown in FIGS. 4 to 7, first image portions 21, 121 are the same, second images portions 25, 125 are the same, and therefore continuous images 27, 127 are the same. Additionally, first images 21, 121 are the same length as second image portions 25, 125 (A=B).

FIG. 8 shows a schematic top view of a portion of web 30 on which printing unit 60 shown in FIGS. 4 to 7 printed two continuous images 27, 127. Image 27 includes a first image portion 21 that is aligned with a second image portion 25, with no unprinted web 30 in between image portions 21, 25. Image 127 includes a first image portion 121 that is aligned with a second image portion 125, with no unprinted web 30 in between images portions 121, 127. Additionally, no unprinted web 30 remains between images 27, 127. First image portions 21, 121 each have a longitudinal length A, while the second image portions 25, 125 each have a longitudinal length of B. Therefore, images 27, 127 each have a cutoff equal to the length of one first image portion 21, 121, A, plus the length of one second image portion 25, 125, B, respectively (A+B).

For the embodiment shown in FIGS. 4 to 7, the distance of web 30 between cylinders 20 and 24 does not have to be an exact length as long as the rotation of cylinders 20 and 24 are appropriately phased. To print continuous image 27 and 127 immediately after one another, with no unprinted web in between, the rotation of cylinders 20, 24 (FIGS. 4 to 7) are phased so that cylinder 24 begins printing image portions 25, 125 immediately after image portions 21, 121, respectively, pass by a nip formed by cylinder 24 and impression cylinder 16 on web 30. The rotation of cylinder 20 (FIGS. 4 to 7) are phased so that cylinder 20 prints images portion 21, 121 with a spacing of length B, the length of image portion 25, in between image portions 21, 121 on web 30.

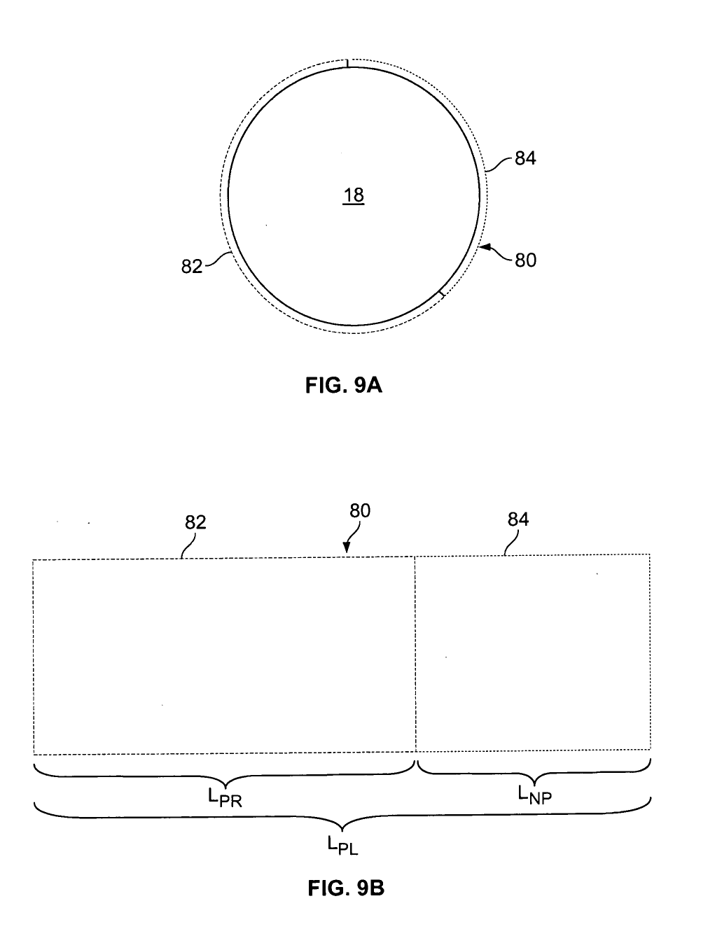

FIG. 9a shows a schematic side view of first plate cylinder 18 shown in FIGS. 4 to 7, with plate 80 disposed about the surface of plate cylinder 18. FIG. 9b shows a schematic top view of plate 80 shown in FIG. 9a removed from plate cylinder 18 and laying flat. First image portions 21, 121 (FIG. 8) are printed by plate 80 on first plate cylinder 18.

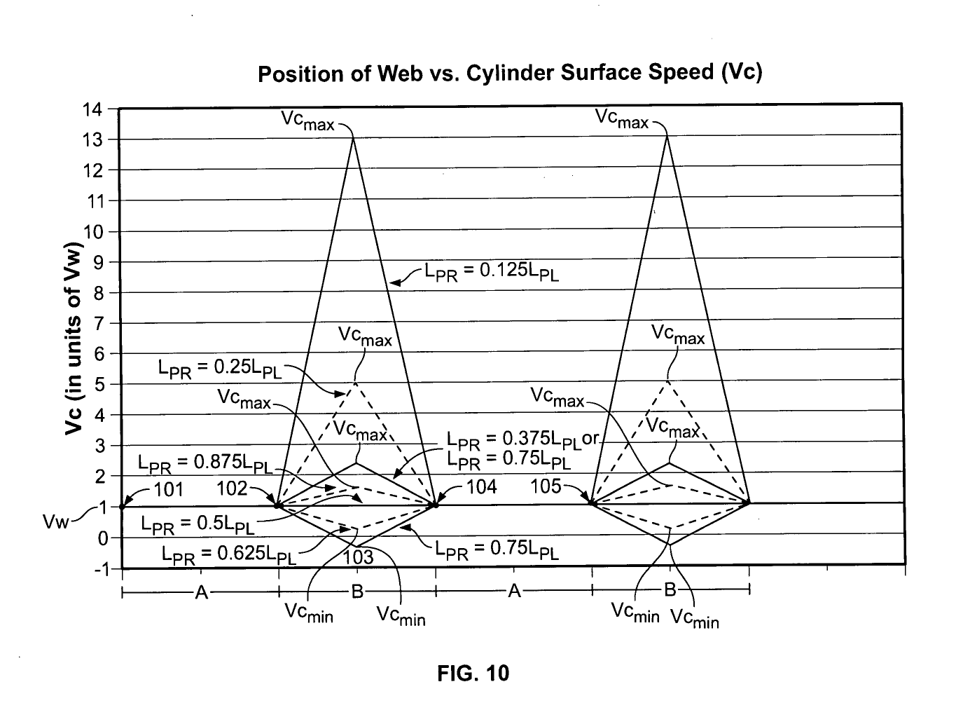

As shown schematically in FIGS. 9a and 9b plate 80 includes a printing portion 82 of a printing length L_{PR} and a nonprinting portion 84, or blank portion, of a nonprinting length L_{NP}. The printing length of plate 80 L_{PR}, plus the nonprinting length of plate 80 L_{NP}, equals the plate length of plate 80 L_{PL} (L_{PR}+L_{NP}=L_{PL}). Printing portion 82 of plate 80 prints first image portions 21 and 121, which are the same image, on web 30. Therefore, the printing length of plate 80 L_{PR} is equal to the length of image portions 21 and 121 A (L_{PR}=A). In the embodiment shown in FIGS. 4 to 7, which applies for illustrative purposes related to FIG. 10, the plate length of plate 80 L_{PL} substantially equals the distance of the circumference of blanket cylinder 20. Because plate 80 prints image portions 21 and 121 on blanket cylinder 20, blanket cylinder 20 also has a printing length equal to printing length of plate 80 L_{PR} and a nonprinting length equal to the nonprinting length of plate 80 L_{NP}.

A plate is also disposed about the surface of plate cylinder 22 (FIGS. 4 to 7) that has a plate length equal to the plate length of plate 80 L_{PL} and the distance of the circumference of the plate as disposed about cylinder 22 is equal to the distance of the circumference of plate 80 as disposed about cylinder 18, which also equals the distance of the circumference of blanket cylinder 24. A printing portion of the plate of cylinder 22 (FIGS. 4 to 7) prints second image portions 25, 125 (FIG. 8), which are the same image. Because second image portions 25,125 (FIG. 8) are equal to first image portions 21, 121 (FIG. 8), the printing length and the nonprinting length of the plate of cylinder 22 are equal to the printing length of plate 80 L_{PR} and nonprinting length of plate 80 L_{NP}, respectively.

When printing length of plate 80 L_{PR} is less than the plate length of plate 80 L_{PL} as shown schematically in FIGS. 9a and 9b, in order for cylinder 20 to print first image portion 21 on web 30 and then be in proper position to print image portion 121 on web 30, cylinders 18, 20 may be accelerated immediately after going off impression and then decelerated back to the web speed so blanket cylinder 20 can print first image portion 121 on web 30. Alternatively, blanket cylinder 20 may be decelerated after printing image portion 21, while off impression, and then accelerated back to web speed to print first image portion 121. When the printing length of plate 80 L_{PR} equals the plate length of plate 80 L_{PL}, or the printing length of plate 80 L_{PR} equals one half of the plate length of plate 80 L_{PL} (L_{PR}=L_{PL}, L_{PR}=½L_{PL}), cylinders 18, 20 maintain a constant speed both on and off impression.

As shown in FIG. 10, whether cylinders 18, 20 (FIG. 4 to 7) may preferably be accelerated or decelerated when going off impression depends on the ratio of the printing length of plate 80 L_{PR} to the plate length of plate 80 L_{PL}. If the printing length of plate 80 L_{PR} is less than half of the plate length of plate 80 L_{PL}, (L_{PR}<0.5L_{PL}) then cylinders 18, 20 preferably accelerate while going off impression and then decelerate back to the velocity of web 30 Vw when going back on impression. This allows the surfaces of cylinders 18, 20 to travel a distance equal to the nonprinting length of plate 80 L_{NP} while the web travels a distance equal to the printing length of plate 80 L_{PR}. Thus, the printing portion 82 of plate 80 is aligned to print image portion 121 a distance on web 30 equal to the printing length of plate 80 L_{PR} after the end of image portion 21, leaving sufficient space on web 30 for cylinder 24 to print image portion 25.

If the printing length of plate 80 L_{PR} is greater than half of the plate length of plate 80 L_{PL}, but less than three-quarters of the plate length of plate 80 L_{PL} (0.5L_{PL}>L_{PR}<0.75L_{PL}), then cylinders 18, 20 are preferably decelerated while printing pair 19 goes off impression and then accelerated back to the web velocity Vw when going back on impression. This allows the surfaces of cylinders 18, 20 to travel a distance equal to nonprinting length of plate 80 L_{NP} while web 30 travels a distance equal to the printing length of plate 80 L_{PR}.

However, in order for cylinders 18, 20 to decelerate and accelerate constantly while off impression, when the printing length of plate 80 L_{PR} is greater than two-thirds of the plate length of plate 80 L_{PL} but less than three-quarters of the plate length of plate 80 L_{PL} (0.667_{PL}>L_{PR}<0.75L_{PL}), motor 14 may have to reverse the direction that cylinders 18, 20 are rotating and rotate cylinders 18, 20 in an opposite direction. Cylinders 18, 20 rotating in this opposite direction are defined as traveling at a negative velocity, as shown in FIG. 10 at point 103 for Xp=0.75Xc. Therefore, to eliminate reverse rotation of cylinders 18, 20 it may only be desirable that cylinders 18 and 20 are constantly decelerated while printing pair 19 goes off impression and then constantly accelerated to go back to web velocity Vw when going back on impression if the printing length of plate 80 L_{PR} is greater than one half of the plate length of plate 80 L_{PL}, but less than or equal to two-thirds of the plate length of plate 80 L_{PL} (0.5_{PL}>L_{PR}<0.667_{PL}).

If the printing length of plate 80 L_{PR} is greater than or equal to three-quarters of the distance of the plate length of plate 80 L_{PL} (L_{PR}≧0.75 L_{PL}), then, in a preferred embodiment, cylinders 18, 20 are accelerated while going off impression and then decelerated back to the web speed Vw when going back on impression. In this configuration too great of change in velocity may be necessary in a short of period of time to decelerate when going off impression and then accelerate back to web velocity Vw and properly align cylinder 20 to print a first image portion on web 30 when printing pair 19 goes back on impression. Therefore, cylinders 18, 20 preferably perform more than an entire revolution and travel a distance equal to the plate length of plate 80 L_{PL} plus the nonprinting length of plate 80 L_{NP} in the time web 30 to travels a distance equal to the printing length of plate 80 L_{PR}. As discussed above, it may also be desirable to accelerate in this same manner when the the printing length of plate 80 L_{PR} is greater than or two-thirds of the plate length of plate 80 L_{PL} (L_{PR}>0.667 L_{PL}) to avoid reverse rotation of cylinder 20.

In situations where the printing length of the plate 80 L_{PR} is less than the one half the plate length of plate cylinder 80 L_{PL} (L_{PR}<0.5L_{PL}), cylinders 18, 20 are preferably accelerated off impression. The surface of each cylinder 18, 20 needs to travel a distance equal to the nonprinting length of plate 80 L_{NP} in the same amount of time web 30 travels a distance equal to the printing length of plate 80, in order to be in proper position to print image portion 121. Therefore, because web 30 travels a distance equal to the printing length of plate 80 L_{PR} at a constant web velocity Vw the surfaces of cylinders 18, 20 has to travel a distance that equals the nonprinting length of plate 80 L_{NP} at an average off impression speed Vcₐᵥₑ that equals the printing length of plate 80 L_{PR} divided by the nonprinting length of plate 80 L_{NP}, multiplied by the web velocity Vw (Vcₐᵥₑ=(L_{NP}/L_{PR})*Vw; because L_{PR}/Vw=L_{NP}/Vcₐᵥₑ). When the surface of each cylinder 18 and 20 reaches a maximum off impression velocity Vcₘₐₓ at a time when web 30 has traveled a distance equal to half of the printing length of plate 80 L_{PR} since printing pair 19 went off impression and cylinders 18, 20 are accelerated and decelerated constantly off impression, the maximum off impression velocity of the surface of each cylinder 18, 20 Vcₘₐₓ equals two times the average velocity of the surface of each cylinder 18, 20 Vcₐᵥₑ minus the web velocity Vw (Vcₘₐₓ=2Vcₐᵥₑ−Vw=2*(L_{NP}/L_{PR})*Vw−Vw).

In situations where the printing length of plate 80 L_{PR} is greater than half of the plate length of plate 80 L_{PL}, but less than three-quarters of the plate length of plate 80 L_{PL} (0.5L_{PL}>L_{PR}<0.75L_{PL}), cylinders 18, 20 are preferably decelerated off impression. The surface of each cylinder 18, 20 needs to travel a distance equal to the nonprinting length of plate 80 L_{NP} in the same amount of time web 30 travels a distance equal to the printing length of plate 80, in order to be in proper position to print image portion 121. Therefore, because web 30 travels a distance equal to the printing length of plate 80 L_{PR} at a constant web velocity Vw the surfaces of cylinders 18, 20 have to travel a distance that equals the nonprinting length of plate 80 L_{NP} at an average off impression speed Vcₐᵥₑ that equals the printing length of plate 80 L_{PR} divided by the nonprinting length of plate 80 L_{NP}, multiplied by the web velocity Vw (Vcₐᵥₑ=(L_{NP}/L_{PR})*Vw; because L_{PR}/Vw=L_{NP}/Vcₐᵥₑ). When the surface of each cylinder 18, 20 reaches a minimum off impression velocity Vcₘᵢₙ when web 30 has traveled a distance equal to half of the printing length of plate 80 L_{PR} since printing pair 19 went off impression and cylinders 18, 20 are decelerated and accelerated constantly off impression, the minimum off impression velocity of the surface of each cylinder 18, 20 Vcₘᵢₙ equals two times the average velocity of the surface of each cylinder 18, 20 Vcₐᵥₑ minus the web velocity Vw (Vcₘᵢₙ=2Vcₐᵥₑ−Vw=2*(L_{NP}/L_{PR})*Vw−Vw).

In situations where the printing length of plate 80 L_{PR} is greater than or equal to three-quarters of the distance of the plate length of plate 80 L_{PL} (L_{PR}≧0.75 L_{PL}), cylinders 18, 20 are preferably accelerated off impression. The surface of each cylinder 18, 20 needs to travel a distance equal to the nonprinting length of plate 80 L_{NP} plus the plate length of plate 80 in the same amount of time web 30 travels a distance equal to the printing length of plate 80, in order to be in proper position to print image portion 121. Therefore, because web 30 travels a distance equal to the printing length of plate 80 L_{PR} at a constant web velocity Vw the surfaces of cylinders 18, 20 has to travel a distance that equals the nonprinting length of plate 80 L_{NP} plus the plate length of plate 80 at an average off impression speed Vcₐᵥₑ that equals the printing length of plate 80 L_{PR} divided by the nonprinting length of plate 80 L_{NP}, multiplied by the web velocity Vw (Vcₐᵥₑ=(L_{NP}/L_{PR})*Vw; because L_{PR}/Vw=L_{NP}/Vcₐᵥₑ). When the surface of each cylinder 18, 20 reaches a maximum off impression velocity Vcₘₐₓ at a time when web 30 has traveled a distance equal to half of the printing length of plate 80 L_{PR} since printing pair 19 went off impression and cylinders 18 and 20 are accelerated and decelerated constantly off impression, the maximum off impression velocity of the surface of each cylinder 18, 20 Vcₘₐₓ equals two times the average velocity of the surface of each cylinder 18, 20 Vcₐᵥₑ minus the web velocity Vw (Vcₘₐₓ=2Vcₐᵥₑ−Vw=2*((L_{NP}+L_{PL})/L_{PR})*Vw−Vw).

FIG. 10 shows a graph of the position of web 30 versus the surface speed of cylinders 18, 20 Vc for various ratios of printing length of plate 80 L_{PR} to the plate length of plate 80 L_{PL} according to the operations performed by printing press 60 shown in FIGS. 4 to 7, with the first plate cylinder 18 including plate 80 shown in FIGS. 9a and 9b. Each line on the graph represents a different ratio of the printing length of plate 80 L_{PR} to the plate length of plate 80 L_{PL}, according to the example discussed above in relation to FIGS. 8, 9a and 9b.

Between points 101, 102, for all ratios of printing length of plate 80 L_{PR} to the plate length of plate 80 L_{P} shown in FIG. 10, printing pair 19 (FIGS. 4 to 7) is on impression traveling at web speed Vw while blanket cylinder 20 prints image portion 21 (FIG. 8), which is a length A, on web 30, as shown in FIG. 4. At point 102, printing pair 19 goes off impression to leave a blank space having distance of length B, for cylinder 24 (FIGS. 4 to 7) to print image portion 25 (FIG. 8). Between points 102, 104 cylinders 18, 20 will travel at different cylinder surface speeds Vc for different ratios of the print length of plate 80 L_{PR} to the plate length of plate 80 L_{PL} as web 30 travels a distance of length B. While web 30 travels between point 102 and web position 103 printing pair 19 goes off impression, as shown in FIG. 5, and cylinders 18, 20 are constantly accelerated or decelerated until the surfaces of cylinders 18, 20 reach a maximum velocity Vcₘₐₓ or a minimum velocity Vcₘᵢₙ at web position 103 (depending on the ratio of the print length of plate 80 L_{PR} to the plate length of plate 80 L_{PL,} as discussed above). While web 30 travels between web position 103 and point 104 cylinders 18, 20 are constantly decelerated or accelerated (depending on the ratio of the print length of plate 80 L_{PR} to the plate length of plate 80 L_{PL}) so that blanket cylinder 20 is traveling at web speed Vw when printing pair 19 goes on impression at point 104. Between points 104, 105 printing pair 19 is on impression, as shown in FIG. 6, and blanket cylinder 20 prints image 121 (FIG. 8), which is a length A, on web 30 while web 30 travels a distance B. At point 105 printing pair 19 goes off impression, as shown in FIG. 7, and cylinders 18, 20 are accelerated to a maximum velocity Vcₘₐₓ or a minimum velocity Vcₘᵢₙ and then constantly decelerated or accelerated back to web speed Vw in the same manner as after printing image 21 at point 102, leaving a space of length B for cylinder 24 to print image portion 125 (FIG. 8).

When the printing length of plate 80 L_{PR} equals three-fourths the distance of the circumference of plate 80 as disposed about cylinder 18 (L_{PR}=0.75L_{PL}), as shown in FIG. 10, approximately the same force is required to either accelerate or decelerate cylinders 18, 20 when initially going off impression, because the difference in web velocity Vw and maximum off impression velocity of cylinders 18, 20 Vcₘₐₓ when cylinders 18, 20 are accelerated is the same as the difference in web velocity Vw and minimum off impression velocity Vcₘᵢₙ when cylinder 20 is decelerated. However, as stated above, Vcₘᵢₙ may be a negative value, which may be undesirable.

FIG. 10 shows that at certain printing lengths of plate 80 L_{PR} cylinders 18, 20, while off impression, must be driven to a much greater velocity than the velocity at which cylinders 18,20 are being driven while on impression, or at web velocity Vw, therefore requiring cylinders 18, 20 to be accelerated at higher rates. Printing lengths of plate 80 L_{PR} that require great changes in velocity off impression and corresponding image lengths and cutoffs, may be less desirable because more energy is expended by whatever motor 14 (FIGS. 4 to 7) driving cylinder 20.

The velocities and accelerations discussed above for cylinders 18 and 20 may also apply to rotation of cylinders 22 and 24 off impression. The cylinders 18, 20, 22, 24 may also be accelerated and decelerated in a variable manner.

Controller 100, which in FIGS. 4 to 7 controls motors 14, 15, may also limit the off impression accelerations or velocities according to the characteristics of motors 14, 15. Therefore, motors 14, 15 could not attempt to reach accelerations or velocities that would damage the respective motor 14, 15 or limit the working life of the respective motor 14, 15.

Although only two printing pairs are shown in the preceding embodiments for each printing unit, any integer number of printing pairs may make up one color for a particular cut off. Additional printing pairs may allow a printing unit to print images having cut off lengths that are much larger than the circumference of any individual plate cylinder. Regardless of the number of printing pairs in a printing unit, the division of the cut off, or in other words, the portion of the image printed by a particular printing pair in relation to the other printing pairs of that printing unit, may not necessarily be equal. Therefore, for example, if there are five printing pairs in a printing unit, each printing pair does not necessarily have to print an image portion that equals 20% of the full image. In this example, one pair could print 15%, a second 30%, a third 20%, a fourth 10% and a fifth could print 25% of the full image. In this arrangement, the rotation and alignment of each blanket cylinder would have to be adjusted accordingly.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A variable cutoff printing press comprising:
a first plate cylinder;
a first plate having a first image portion disposed about the first plate cylinder;
a first blanket cylinder transferring the first image portion to a web at a first location;
a second plate cylinder;
a second plate having a second image portion disposed about the second plate cylinder;
a second blanket cylinder transferring the second image portion to the web at a second location;
an impression cylinder contacting the first blanket cylinder and the second blanket cylinder via the web;
wherein the first image portion and the second image portion form one continuous image having an image cutoff length.

2. The variable cutoff printing press recited in claim 1 wherein a first motor drives the first blanket cylinder and a second motor drives the second blanket cylinder.

3. The variable cutoff printing press recited in claim 2 wherein a controller controls the first motor and the second motor.

4. The variable cutoff printing press recited in claim 2 wherein the first motor drives the first blanket cylinder at a web speed when the first blanket cylinder is in contact with the impression cylinder and dynamically adjusts the position of the first blanket cylinder when the first blanket cylinder is not in contact with the impression cylinder, and the second motor drives the second blanket cylinder at a web speed while the second blanket cylinder is in contact with the impression and dynamically adjusts the position of the second blanket cylinder when the second blanket cylinder is not in contact with the impression cylinder.

5. The variable cutoff printing press recited in claim 1 wherein the first image portion and the second image portion are the same color.

6. The variable cutoff offset printing press recited in claim 5 further comprising:
a third plate cylinder;
a third plate having a third image portion disposed about the third plate cylinder;
a third blanket cylinder transferring the third image portion to the web at the first location;
a fourth plate cylinder;
a fourth plate having a fourth image portion disposed about the fourth plate cylinder;
a fourth blanket cylinder transferring the fourth image portion to the web at the second location; and
a second impression cylinder contacting the third blanket cylinder and the fourth blanket cylinder via the web;
wherein the third image portion and the fourth image portion form a second continuous image having a second image cutoff length that is substantially the same as the image cutoff length of the first continuous image and the third image portion and the fourth image portion are the same color, which is different from the color of the first image portion and the second image portion,
wherein the first continuous image and the second continuous image form a continuous two color image.

7. The variable cutoff offset printing press recited in claim 6 further comprising:
a first motor driving the first blanket cylinder;
a second motor driving the second blanket cylinder;
a third motor driving the third blanket cylinder;
a fourth motor driving the fourth blanket cylinder; and
a controller controlling the first motor, the second motor, the third motor and the forth motor.

8. The variable cutoff offset printing press recited in claim 5 further comprising:
a third plate cylinder;
a third plate having a third image portion disposed about the third plate cylinder;
a third blanket cylinder transferring the third image portion to the web at the first location;
a fourth plate cylinder;
a fourth plate having a fourth image portion disposed about the fourth plate cylinder; and
a fourth blanket cylinder transferring the fourth image portion to the web at the second location;
wherein the impression cylinder contacts the third blanket cylinder and the fourth blanket cylinder via the web;
wherein the third image portion and the fourth image portion form a second continuous image having a second image cutoff length that is substantially the same as the image cutoff length of the first continuous image and the third image portion and the fourth image portion are the same color, which is different from the color of the first image portion and the second image portion,
wherein the first continuous image and the second continuous image form a continuous two color image.

9. The variable cutoff printing press recited in claim 1 further comprising a nip roll guiding the web.

10. The variable cutoff printing press recited in claim 1 wherein the first image portion and the second image portion are of equal length.

11. The variable cutoff printing press recited in claim 1 wherein the first plate cylinder, the first blanket cylinder, the second plate cylinder, and the second blanket cylinder all have the same outer circumference.

12. The variable cutoff printing press recited in claim 1 wherein the first plate can be removed and replaced with a first replacement plate having a replacement first image portion that is a different length than the first image portion and the second plate can be removed and replaced with a second replacement plate having a replacement second image portion that is a different length than the second image portion;
wherein the replacement first image portion and the replacement second image portion form one continuous replacement image having a replacement image cutoff length that vary from the image cutoff length.

13. The variable cutoff offset printing press recited in claim 12 further comprising:
a controller controlling movement of the first and second plate cylinders as a function of the cutoff length.

14. A method of printing an image on a web with a cutoff using a variable cutoff offset printing press comprising the steps of:
dynamically adjusting the position of a first blanket cylinder while the first blanket cylinder is not in contact with an impression cylinder;
moving the first blanket cylinder into contact with the impression cylinder and printing a first image portion transferred to the first blanket cylinder by a first plate of a first plate cylinder on the web while the position of the second blanket cylinder is dynamically adjusted while the second blanket cylinder is not in contact with the impression cylinder;
moving the second blanket cylinder into contact with the impression cylinder and printing a second image portion transferred to the second blanket cylinder by a second plate of a second plate cylinder in a position on the web that is aligned with the second image portion so as to form a continuous image on the web having a first image cutoff length;
removing the first plate and replacing the first plate with a first replacement plate having a second replacement image portion and removing the second plate and replacing the second plate with a second replacement plate having a second replacement image portion; and
transferring the first replacement image portion to the first blanket cylinder and printing the first replacement image portion on the web and transferring the second replacement image portion to the second plate cylinder and printing the second replacement image portion on the web so that the first replacement image portion and the second replacement image portion form a continuous replacement image on the web having a second image cutoff length.
